(19) United States
(12) Patent Application Publication
(10) Pub. No.: US 2017/0168689 A1
(43) Pub. Date: Jun. 15, 2017

(54) SYSTEMS AND METHODS FOR PROVIDING VEHICLE-RELATED INFORMATION IN ACCORD WITH A PRE-SELECTED INFORMATION-SHARING MODE

(71) Applicant: GM Global Technology Operations LLC, Detroit, MI (US)

(72) Inventors: Claudia V. Goldman-Shenhar, Mevasseret Zion, IL (US); Eric L. Raphael, Birmingham, MI (US)

(21) Appl. No.: 14/967,674

(22) Filed: Dec. 14, 2015

(51) Int. Cl. G06F 3/0484; G06F 3/0482; G06F 9/44; B60Q 9/00

(52) U.S. Cl. CPC G06F 3/04847; B60Q 9/00; G06F 3/04842; G06F 3/0482; G06F 9/4446

(57) ABSTRACT

A vehicle system, for use in communicating in a customized manner with a vehicle user. The system includes a processing hardware unit and a tangible communication device in communication with the processing hardware unit for receiving user input and/or delivering vehicle output. The system further includes an interaction-level determination module configured to, by way of the processing hardware unit, determine, based on user-context data, an applicable interaction-level mode for use in communicating with the vehicle user. The system also includes an interaction-level actualization module configured to, by way of the processing hardware unit, initiate provision of one or more vehicle-related messages in a manner consistent with the interaction-level mode determined. The system can be, or be part of, a vehicle system. The disclosure also provides methods for using such systems.

### TECHNICAL FIELD

The present disclosure relates generally to systems for providing vehicle-related information to users selectively and, more particularly, to systems providing vehicle-related information to users based on a pre-selected one of multiple pre-established information-sharing modes.

### BACKGROUND

Manufacturers are increasingly producing vehicles with higher levels of driving automation and vehicle-user interaction. Features such as adaptive cruise control and lane keeping have become popular and are precursors to greater adoption of fully autonomous-driving-capable vehicles.

While automation and availability of high-volume information are on the rise, users' familiarity and comfort with these functions will not necessarily keep pace. User trust in the automation, and comfort with vehicle-user communications, are important considerations.

### SUMMARY

The present disclosure relates to a vehicle system, for use in communicating in a customized manner with a vehicle user. The vehicle system includes a processing hardware unit and a tangible interface device in communication with the processing hardware unit for receiving user input and/or delivering vehicle output. The vehicle system also has a plurality of modules, including an interaction-level determination module configured to, by way of the processing hardware unit, determine, based on user-context data, an applicable interaction-level mode for use in communicating with the vehicle user. The vehicle system further includes an interaction-level actualization module configured to, by way of the processing hardware unit, initiate provision of one or more vehicle-related messages in a manner consistent with the interaction-level mode determined.

In various embodiments, the user-context data includes input data indicating a user-selected interaction-level mode of a plurality of predetermined interaction-level mode options presented to the user.

In various embodiments, the plurality of predetermined interaction-level mode options comprise three or four options.

In some embodiments, the input data is received from the tangible interface device including an in-vehicle knob or dial configured to receive user selection of one of the predetermined interaction-level mode options.

In one or more embodiments, the input data is received from the tangible interface device including an in-vehicle display screen configured to receive user selection of one of the predetermined interaction-level mode options.

In various embodiments, the manner includes at least one factor selected from a group consisting of (i) a volume of messages to be communicated, (ii) a timing by which to communicate the message(s), (iii) a message format by which to communicate the message(s), (iv) whether a user confirmation is requested prior to performance of a vehicle action suggested to the user, and (v) an applicable communication channel by which to communicate the message(s).

In some embodiments, the manner includes an applicable communication channel by which to communicate the message(s) and the applicable communication device includes the tangible interface device.

In one or more embodiments, the manner includes an applicable communication channel by which to communicate the message(s) and the applicable communication device is a user device remote to the vehicle system.

In various embodiments, the vehicle system of claim 1, wherein the user-context data includes user-activity data indicating user behavior.

In various embodiments, the interaction-level actualization module is configured to, by way of the processing hardware unit, determine or generate the one or more vehicle-related messages based on the applicable interaction-level mode determined.

In various embodiments, the vehicle system includes a user-profile module configured to be used by the processing hardware unit in determining the manner by which to provide the one or more vehicle-related messages.

In some embodiments, the user-profile module includes user-preference data, user-activity data, and/or user-behavior data.

In one or more embodiments, the vehicle system includes a tutoring module configured to, by way of the hardware processing unit, generate a tutoring message to educate the vehicle user about vehicle-system operation and thereby engender driver confidence in the vehicle system.

In at least one embodiment, the tutoring module is configured to initiate communication of the tutoring message for receipt by the vehicle driver in advance of a corresponding vehicle function, during the corresponding vehicle function, and/or after the corresponding vehicle function.

In various embodiments, the technology includes a system, for use in communicating in a customized manner with a vehicle user. The system includes a processing hardware unit, and at least the two modules described above: the interaction-level determination module and the interaction-level actualization module.

In various embodiments, the technology includes a process, for use in communicating in a customized manner with a vehicle user. The process includes determining, by a processing hardware unit executing code of an interaction-level determination module of a tangible system, based on user-context data, an applicable interaction-level mode for use in communicating with the vehicle user. The process also includes initiating, by the processing hardware unit executing code of an interaction-level actualization module of the tangible system, provision of vehicle-related messages in a manner consistent with the interaction-level mode determined.

Other aspects of the present technology will be in part apparent and in part pointed out hereinafter.

### DESCRIPTION OF THE DRAWINGS

FIG. 1 illustrates schematically a first example, autonomous-driving-capable, vehicle comprising an interface system according to an embodiment of the present disclosure.

FIG. 2 illustrates a first example system-user interface device according to an embodiment of the present disclosure.

FIG. 3 illustrates a second example system-user interface device according to an embodiment of the present disclosure.

FIG. 4 illustrates methods of using the vehicle and system of FIG. 1, and devices of FIGS. 2 and 3, according embodiments of the present disclosure.

FIG. 5 illustrates schematically a second example vehicle, like that of FIG. 1, but including a control system according to another embodiment of the present disclosure.

FIG. 6 illustrates a third example system-user interface device.

FIG. 7 illustrates a fourth example system-user interface device.

FIG. 8 illustrates methods of using the second vehicle and devices of FIGS. 5-7.

The figures are not necessarily to scale and some features may be exaggerated or minimized, such as to show details of particular components.

In some instances, well-known components, systems, materials or methods have not been described in detail in order to avoid obscuring the present disclosure.

Specific structural and functional details disclosed are not to be interpreted as limiting, but merely as a basis for the claims teaching one skilled in the art to variously employ the present disclosure.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model, or pattern.

Specific structural and functional details disclosed herein are not to be interpreted as limiting, but merely as a basis for the claims and as a representative basis for teaching one skilled in the art to employ the present disclosure.

While the present technology is described primarily herein in connection with automobiles, the technology is not limited to automobiles. The concepts can be used in a wide variety of applications, such as in connection with aircraft and marine craft.

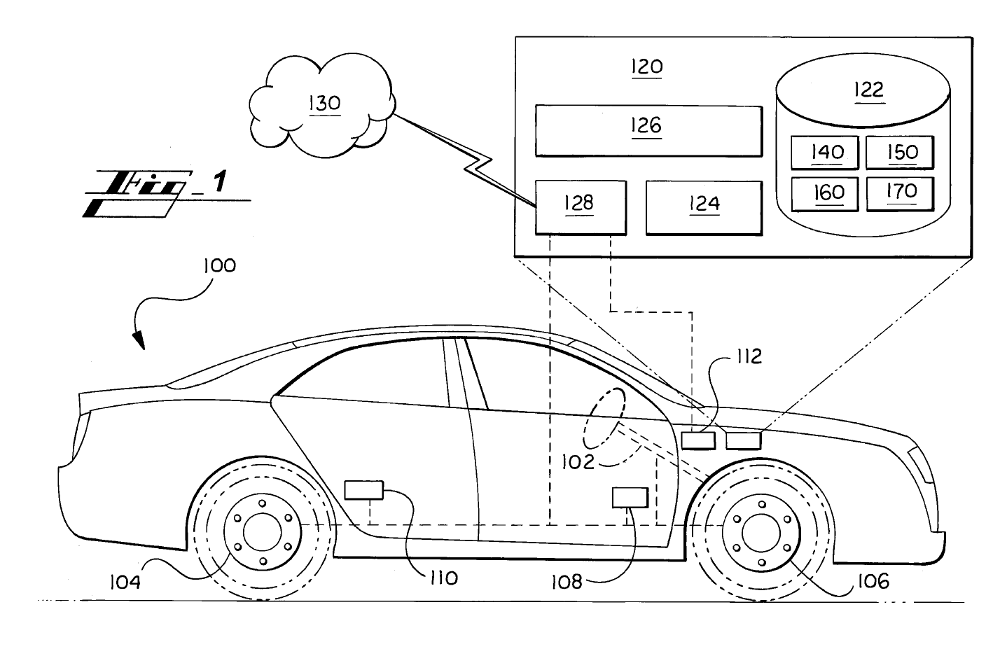

I. First Example System Overview—FIGS. 1-3

The present disclosure describes a vehicle-user-interaction system. The vehicle-user-interaction system is configured and arranged in an autonomous-driving-capable vehicle to deliver and receive communications to and from the user. The interactions are performed in accord with a select level of interaction corresponding to the user.

In some implementations, a degree of the interactions for the user is determined by the system based on an express user communication of the interaction level desired. In some implementations, the system determines an applicable level of interaction based on factors such as any pre-established user setting or preference, user communications, or other behavior of the user.

Generally, the system is configured to interact more with users who have requested or would apparently benefit most from higher levels of interaction. The interaction in various embodiments includes information advising the user of planned autonomous driving functions, requests for approval to perform such functions, and information describing how or reasons why an immediately preceding autonomous-driving function was performed. The system is configured to provide experienced users, who are more comfortable using autonomous-driving functions, with little to no interaction beyond the information that the autonomous-driving system may otherwise provide.

As an example, for a novice user, the vehicle-user-interaction system may in addition to default illumination of a dashboard light or screen display indicating that the vehicle is passing another vehicle, the vehicle-user-interaction system may provide the novice user with other advance notice, such as by way of a gentle voice through vehicle speakers, indicating that the vehicle is preparing to safely pass a slow-moving vehicle ahead. For an expert user, on the other hand, the vehicle-user-interaction system may not add any communications, to supplement the default dashboard light mentioned, in connection with passing the slower vehicle.

While two primary user statuses, novice and expert modes are described in the preceding paragraphs, the vehicle-user-interaction system is configured in various embodiments to include any number of various interaction modes corresponding with respective levels of interaction. In one implementation, there is a fully-manual interaction mode and four autonomous-driving interaction modes, including a fully-automated interaction mode.

In one embodiment, the vehicle-user-interaction system is configured to allow the user to set the interaction level by way of a human-machine interface (HMI) such as a knob, dial, or touch-sensitive screen. In various embodiments, the vehicle-user-interaction system is configured to determine a recommended system interaction level for the user based on user communications, settings, preferences, or behavior, such as driving behavior or responses to autonomous-driving actions.

II. First Example System Components—FIG. 1

Now turning to the figures, and more particularly to the first figure, FIG. 1 illustrates a schematic diagram of an autonomous-driving-capable vehicle 100, in accordance with embodiments of the present disclosure.

The vehicle 100 comprises numerous components including a steering assembly 102, one or more braking assemblies 104, 106, and an acceleration assembly 108. Other vehicle-control components that can be used with the present technology are indicated generically at reference numeral 110. In various embodiments, the vehicle control components are computer controllable to affect driving of the vehicle.

The vehicle 100 also includes one or more vehicle-user interfaces 112. The vehicle-user interface(s) 112 include hardware by which a user, such as a driver of the vehicle, can provide input to and/or receive output from a computerized controller of the vehicle. The interface(s) 112, like all components described herein, can be referred to by a variety of terms. The interface(s) 112 can be referred to, for instance, as a vehicle-driver interface (VDI), a human-machine interface (HMI), a vehicle input, a vehicle I/O, or the like.

FIG. 1 shows schematically such a computerized controller, or control system 120, for use in accordance with embodiments of the present disclosure. It is contemplated that the control system 120 can be implemented in one or more of a variety of forms, such as with an onboard computer, in the form of a server, within a mobile communications device, or other.

Although connections are not shown between all of the components illustrated in FIG. 1, the components can interact with each other to carry out system functions.

As shown, the control system 120 includes a memory, or computer-readable storage device 122, such as volatile medium, non-volatile medium, removable medium, and non-removable medium. The term computer-readable media and variants thereof, as used in the specification and claims, refer to tangible or non-transitory, computer-readable storage devices.

In some embodiments, storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

The control system 120 also includes a processing hardware unit 124 connected or connectable to the computer-readable storage device 122 by way of a communication link 126, such as a computer bus.

The processing hardware unit 124 can include or be multiple processors, which could include distributed processors or parallel processors in a single machine or multiple machines. The processing hardware unit can be used in supporting a virtual processing environment. The processing hardware unit could include a state machine, application specific integrated circuit (ASIC), programmable gate array (PGA) including a Field PGA, or state machine. References herein to the processing hardware unit executing code or instructions to perform operations, acts, tasks, functions, steps, or the like, could include the processing hardware unit performing the operations directly and/or facilitating, directing, or cooperating with another device or component to perform the operations.

The computer-readable storage device 122 includes computer-executable instructions, or code. The computer-executable instructions are executable by the processing hardware unit 124 to cause the processing hardware unit, and thus the control system 120, to perform any combination of the functions described in the present disclosure.

The storage device 122 is in various embodiments divided into multiple modules 140, 150, 160, 170, each comprising or being associated with code causing the processing hardware unit 124 to perform functions described herein.

The control-system modules 140, 150, 160, 170 in various embodiments include an interaction-mode-determining module 140, an interaction module 150, a vehicle-maneuver module 160, and one or more other modules 170.

As described more below, the interaction-mode-determining module 140 is configured with computer-executable code designed to cause the processing hardware unit 124 to perform functions related to determining an applicable interaction mode for a particular user.

The interaction module 150 is configured with computer-executable code designed to cause the processing hardware unit 124 to perform functions related to interacting with the user. The functions can include determining what messages to provide to the user and determining what user behaviors (e.g., gestures, driving style) or user communications (e.g., statements or inquiries) advise about the user and user needs.

The messages can include, for instance, (i) responses to user inquiry, (ii) advance notice of a planned autonomous driving maneuver or action, or (iii) a reason, description, or other information related to an autonomous maneuver or action just performed.

The vehicle-maneuver module 160 is configured with computer-executable code to cause the processing hardware unit to initiate performance of an autonomous-driving maneuver or action for the vehicle. The vehicle-maneuver module 160 can be configured to initiate the action in response to any of a variety of triggers, such as in response to user request, user proposal, or determining that the maneuver or action should be taken, for instance.

The fourth illustrated module 170 can represent one or more additional modules. Example functions that code of the additional module(s) 170 can cause the processing hardware unit 124 to perform include building or updating a user profile. The user profile can include, for instance, user settings. The settings can include preferences that the user has input or expressed, or that the system 120 has determined based on user behavior (e.g., driving style, gestures, etc.) or based on user communications (e.g., statements, inquiries, etc.).

Modules 140, 150, 160, 170 can be referred to by a wide variety of terms including by functions they are configured to perform. In the latter example, for instance, the module 170 can be referred to as a user-profile module, a profile-builder module, or the like.

While four modules 140, 150, 160, 170 are illustrated in FIG. 1 by way of example, the non-transitory computer-readable storage device 122 can include more or less modules. Any functions described herein in connection with separate modules can instead, in another embodiment, be performed by the processing hardware unit 124 executing code arranged in a single module. And any functions described herein in connection with a single module can be performed instead by the processing hardware unit 124 executing code of more than one module.

The control system 120 further comprises an input/output (I/O) device 128, such as a wireless transceiver and/or a wired communication port. The device 128 can include, be a part of, or be a tangible communication device, or tangible interface device. The processing hardware unit 124, by way of the I/O device 128, and executing the instructions, including those of the mentioned modules 140, 150, 160, 170, sends and receives information, such as in the form of messages or packetized data, to and from one or more vehicle components, including the vehicle control components 102, 104, 106, 108, 110 mentioned.

In some implementations, the I/O device 128 and processing hardware unit 124 are configured such that the unit 124, executing the instructions, sends and receives information to and from one or more networks 130 for communication with remote systems. Example networks 130 can include the Internet, local-area networks, or other computing networks, and corresponding network access devices include cellular towers, satellites, and road-side short- or medium-range beacons such as those facilitating vehicle-to-infrastructure (V2I).

In some embodiments, such as when the system 120 is implemented within a vehicle 100, the system 120 includes or is connected to one or more local input devices 112 and/or one or more output devices 104, 106, 108, 110, 112, 114.

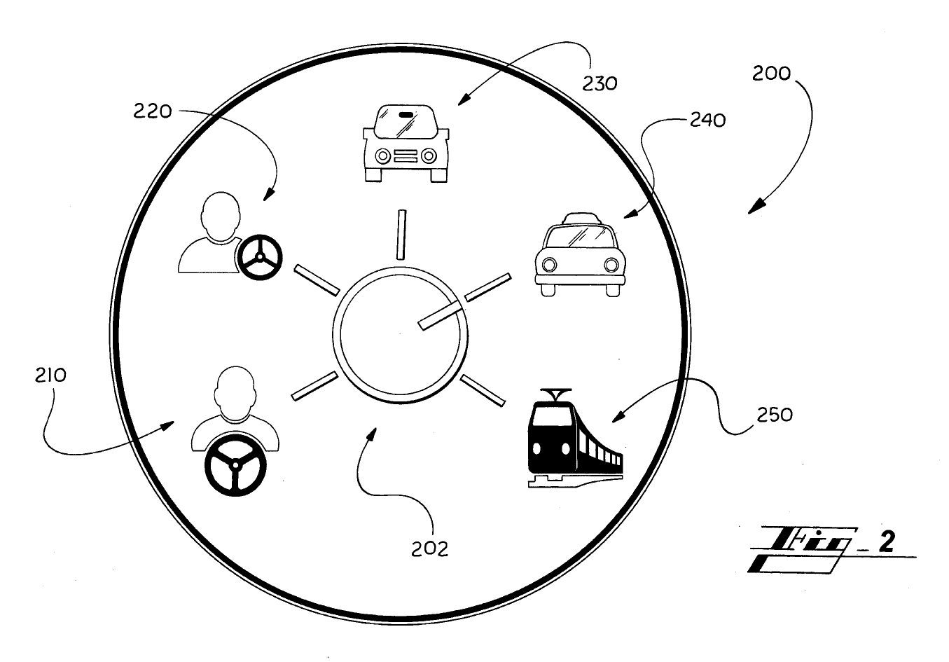

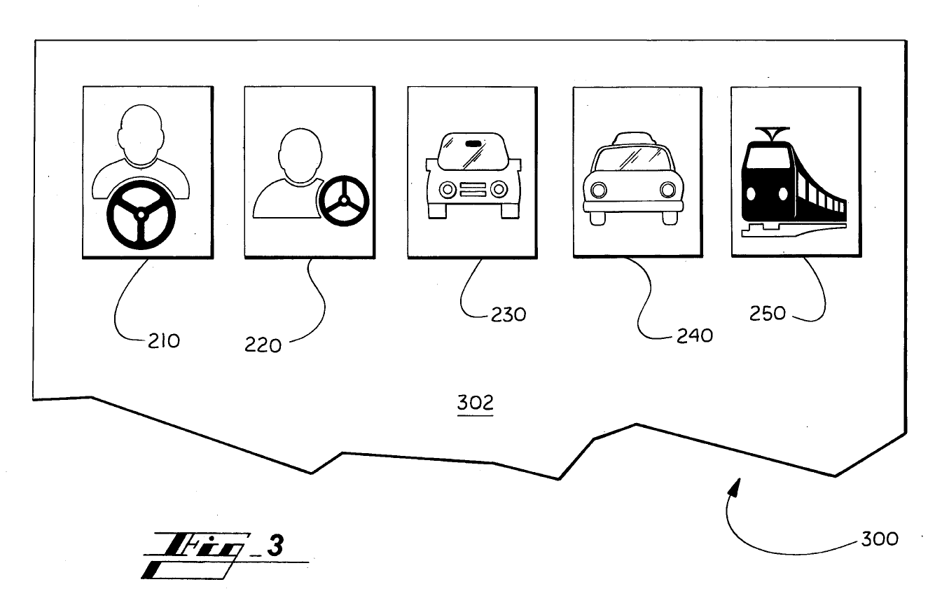

The inputs 112 can include in-vehicle knobs or dials (FIG. 2, for instance), touch-sensitive screens (FIG. 3 for instance), microphones, cameras, laser-based sensors, other sensors, or any device suitable for monitoring or receiving communication from a user (e.g., driver) of the vehicle 100. User communication can include, for instance, gestures, button pushes, or sounds. The user communications can include audible sounds such as voice communications, utterances, or sighs from the user.

The inputs 112 can also include vehicle sensors such as positioning system components (e.g., GPS receiver), speed sensors, and camera systems.

Any of the components described herein can be considered a part of a kit, apparatus, unit, or system. For instance, the vehicle output components 102, 104, et. seq.—e.g., actuators—can be a part of a system including the controller 120. In one embodiment, the controller 120 is a sub-system of a larger system such as, but not limited to, the vehicle 100.

III. First Tangible Input Components—FIGS. 2 and 3

FIGS. 2 and 3 show first example tangible input components 200, 300. The input component 200 of FIG. 2 includes a knob or dial 202 by which the user can indicate which interactive mode the user would like to be associated with in connection with autonomous driving. By the dial 202, the user can select any of a plurality of optional modes.

The system function can be referred to as an “on demand” function by which the user can indicate or demand a level of autonomous-driving-related interaction that they want the system 120 to provide.

FIG. 2 shows five optional modes: a first mode 210 dedicated to fully manual vehicle operation, and five consecutive autonomous-driving interaction modes 220, 230, 240, 250. This number of modes is exemplary, and the control system 120 can be configured with less or more than four autonomous-driving interaction modes 220, 230, 240, 250.

In contemplated embodiments, one or more of the interaction features are not limited to being associated exclusively with a particular interaction mode. The system 120 can be configured to determine, for instance, that while a user has a comfort level equal to an expert passenger (corresponding to the third interaction mode 240 in the primary example provided herein) in connection with most autonomous-driving functionality, the user is not yet comfortable with a certain autonomous-driving function, such as passing on two lane roads. The system 120 can build a user profile to accommodate characteristics of the particular user. The profile may result in a hybrid interaction approach, whereby interaction activities associated generally with various interaction modes are used for the user. This can be the case even if the system 120 or user has separately selected a particularly interaction mode.

The input component 300 of FIG. 3 includes a touch-sensitive display 302 by which the user can indicate which interactive mode the user would like to be associated with in connection with the autonomous-driving-capable vehicle operations. The display 302 can include a screen or other display (a heads-up display arrangement, for example) by which the system can present options from which the user can selection.

By the display 302, the user can select any of a plurality of optional interaction modes. By way of example, FIG. 3 shows the same five modes as shown in FIG. 2: a first interaction mode like that of FIG. 2—indicated again by numeral 210 for simplicity. The first interaction mode 210 corresponds to fully manual vehicle operation. Four consecutive autonomous-driving interaction modes are indicated again by numerals 220, 230, 240, 250.

The system 120 can define more or less than five modes. In various embodiments, the system 120 includes at least three modes: a fully-manual mode, a lower or lowest autonomous-driving interaction mode and a higher or highest autonomous-driving interaction mode. The lowest autonomous-driving interaction mode is suitable for users having little or no experience, or at least having a low comfort level using autonomous-driving functions. The lowest mode of three can include the novice interaction mode 220 described, or a combination of that mode and features of the next higher mode or modes (e.g., 230, or 230 and 240) described primarily herein. The highest mode, or expert, mode can correspond to any or a combination of the top three modes 230, 240, 250 of the five described primarily herein.

In various embodiments, the system 120 is configured to, in connection with some or all of the autonomous-driving interaction modes 230, etc., affect autonomous driving functions of the vehicle 100. The system can affect more- or less-frequent transfers of control between the human driver and the autonomous driving system, for instance, or a manner by which the vehicle cruise control is adapted, or passing maneuvers are performed.

In other embodiments of the present technology, the system 120, or at least the modules described herein (modules 140, 150, etc.), is/are not configured and arranged in the vehicle 100 to affect the autonomous functions of the vehicle, no matter the interaction mode (210, 220, etc.) selected. In this case, the system 120 is configured to interact with the human driver, in accord with the applicable interaction mode (210, 220, etc.) determined, but not to affect autonomous driving functions performed by an autonomous driving system.

As provided, in one embodiment, the autonomous-driving system is configured to, for instance, operate the same whether the interaction system 120 is operating, how the interaction system 120 is operating, or even whether the interaction system 120 is present. For instance, the system 120 would in this case not affect whether, when, or how often transfers of control are made, or a manner by which passing maneuvers are executed.

III.A. Fully Manual Interaction Mode 210

The fully manual driving mode corresponds to non-autonomous operations of the vehicle 100. The mode is appropriate for drivers who do not want to use autonomous driving. They may prefer driving manual for any of a variety of reasons, such as because they lack trust with automated-driving operations, or because they simply prefer to drive manually at the time. The fully manual interaction mode can thus be used in association with driver who is experienced and comfortable with autonomous driving.

In one embodiment, the control system 102 does not interact with the user while in fully manual interaction mode 210.

In another embodiment, the control system 102 provides occasional messages to the user. The message can include, for instance, a suggestion to the user to use autonomous driving, and can indicate the underlying conditions—e.g., “the present condition, including highway driving without much traffic, is ideal for basic autonomous driving.”

In a contemplated implementation, the control system 102 determines whether the user is inexperienced or more experienced. Occasional informative or enquiring communications, such as the example notice of the immediately preceding paragraph, are provided for an inexperienced user, but would not be provided, or would be provided with less information and/or with less frequency for an experienced user.

Regarding selection of the manual-driving interaction mode 210, the processing hardware unit 124 executing code of the mode-selecting module 140 in one embodiment selects the fully manual driving mode 210 based on user express selection. For instance, the user opts for the mode, “on demand,” such as by the dial 200 or screen 300 shown in FIGS. 2 and 3. The processing hardware unit 124 executing code of the mode-selecting module 140 in one embodiment selects the fully manual driving mode 210 based on other present context. The context can include user communications (statements or enquires, for instance) and/or user behavior (gestures, utterances, etc.) indicating that the user does not want to be in any autonomous-driving interaction mode, or is otherwise uncomfortable with the autonomous-driving interaction mode. The context can include, for instance, that the driver indicating to the autonomous-driving-capable vehicle that they want to drive manually, such as by taking control of the steering wheel, pressing the brake, pressing the accelerator, etc.

III.B. Novice Interaction Mode 220

The first and lowest autonomous-driving interaction mode 220 can be referred to by any of a variety of names, including novice autonomous-driving interaction mode, beginner autonomous-driving interaction mode, beginner driver autonomous-driving interaction mode, tutor autonomous-driving interaction mode, new-driver tutor autonomous-driving interaction mode low-trust autonomous-driving interaction mode, low-comfort autonomous-driving interaction mode, lowest-trust autonomous-driving interaction mode, lowest-comfort autonomous-driving interaction mode, new driver autonomous-driving interaction mode, new driver tutor, or the like.

This mode is appropriate for drivers having little or no experience with autonomous driving, or who otherwise have low levels of trust of autonomous driving. While the novice human driver lets the vehicle drive autonomously at times, the system 102 is configured to expect the novice human driver to monitoring the driving constantly or at least heavily.

As provided, at lower autonomous-driving interaction modes, more information is provided to and sought from (e.g., more monitoring of) the human driver. For instance, the system 120 is configured to provide and receive the most amount of communications to/from the human driver—that is, have the highest level of interaction—in the novice autonomous-driving interaction mode as compared to the other autonomous-driving interaction modes (e.g., 230, 240, etc.). The level of interaction increases for each mode—the interaction is lower for the third autonomous-driving interaction mode 240 than for the second autonomous-driving interaction mode 230, for instance.

In addition to the system 120 being configured to expect the novice human driver to be monitoring the autonomous driving heavily in connection with the first autonomous-driving interaction mode 220, the system 120 is configured to expect the human driver to provide communications regarding autonomous vehicle operations. The communications may or may not be expressed for processing by the vehicle 100, and can take any of a variety of forms. For those directed to the vehicle, the human driver expects the vehicle to respond or at least consider the communication in vehicle operations.

Human-driver communications can include, for instance, express orders or statements, inquiries, gestures, or utterances. An example statement or order from the human driver is, “slow down.” Example inquiries include the human driver asking, “can we safely go faster?” or “did you see that pedestrian?”

An example gesture is the human driver putting their hands on their face, perhaps because the human driver is not confident that the vehicle will indeed perform a needed maneuver autonomously. In some embodiments, once the user has selected an interaction mode, such as by a dial device, the system no longer needs to monitor driver actions or communications for determining an applicable mode.

An example utterance could include the human driver exclaiming, “whoa,” in a similar situation—when the human driver is not confident that the vehicle will indeed perform a needed maneuver autonomously.

An example manner for responding to any human-driver communication is for the system to provide for the driver a system statement responsive to the driver communication.

As mentioned, the system 120 can be configured to, in addition to interacting with the human driver at an appropriate level for the first autonomous-driving interaction mode 220 and any autonomous-driving interaction mode, affect autonomous driving functions of the vehicle 100. Another example manner for the system 120 to respond to human-driver communications is adjusting user settings or preferences. Such settings in some embodiments affect autonomous driving functions. As an example of adjusting user preferences, the system 120 can determine that based on human-driver feedback during driving, the human driver would be more comfortable if the system 120 maintained a larger gap between the vehicle 100 and vehicle ahead. In one embodiment, the system can be configured to, given an applicable interaction mode, establish a maximum gap level, in terms of distance or time to stop (e.g., three seconds), for instance, and not change unless the driver requests or permits the change explicitly.

As an example of responding to the driver, the system 120 may state, for instance, “yes, I saw that pedestrian standing near the curb.”

The system 120 may also be configured to proactively advise the human driver, such as letting the driver know that the pedestrian was noticed, to engender trust and confidence in the human driver for the autonomous functions, even in situations in which the human driver does not express an enquiry or unease.

Further regarding affecting autonomous driving functions of the vehicle 100, the system 120 can be configured to affect more- or less-frequent transfers of control between the human driver and the autonomous-driving system. The human driver may also override automated control, and novice drivers are more likely to do so. The system 120 is programmed to expect these situations, such as by being configured to generate a communication, or select a pre-determined communication, that is appropriate to the context. The communication can include, for instance, “that's fine that you took control to avoid the road hazard—just so you know, the automated driving system noticed the hazard and was preparing to make the same maneuver.”

Regarding transfer of driving control (TOC) from the vehicle back to the driver, the system 120 is in various embodiments configured so that, when in the novice interaction mode 220, due to the relatively low levels of confidence or experience, the system 120 generally does not override manual control. In some embodiments, the system 120 is configured to initiate TOC to the vehicle 100 if: (1) the system 120 has prepared the human user for the potential transfer, such as by a gentle message proposing the transfer and receiving human-driver approval for the transfer, or (2) the system 120 determines that some automated control is needed to ensure safety—e.g., if the human driver is apparently having trouble keeping their lane.

III.C. Expert Companion Interaction Mode 230

The second autonomous-driving interaction mode 230 can be referred to by any of a variety of names, including expert companion autonomous-driving interaction mode, medium-trust autonomous-driving interaction mode, medium-comfort autonomous-driving interaction mode, expert new-driver companion autonomous-driving interaction mode, low-trust autonomous-driving interaction mode or low-comfort autonomous-driving interaction mode (if the prior mode is referred to as the lowest-trust or lowest-comfort autonomous-driving interaction mode), or the like.

The human driver, or companion, best associated with this mode 230 would tend to trust the automated driving functions more than the novice driver associated with the prior mode. The driver at this level has more trust and comfort with autonomous driving and will likely at times look away from the driving, such as to read, look at a passenger during conversation, or even close their eyes in rest.

The system 120 is configured, accordingly, with data and algorithms informing the system that, when in the expert companion autonomous-driving interaction mode, the human driver is more comfortable than a novice user, and requires less information about autonomous driving functions. The programing in some implementations also causes the system 120 to monitor the human driver less, such as by monitoring driver communications less.

In a contemplated embodiment, the system 120 can monitor specifically driver communications that are presented in a certain way that indicates that the communications are meant for the vehicle to comprehend, such as by being presented in a certain tone, volume, or direction of voice expression.

Regarding the possibility that the human driver will often not be paying attention, the system 120 is configured to determine or predict risk situations for which the human driver should be alerted.

As mentioned, the system 120 in some embodiments is able to affect autonomous driving functions of the vehicle 100. For embodiments in which the system 120 can affect more- or less-frequent transfers of control between the human driver and the autonomous driving system, automated transfers from the human driver to the vehicle can be more frequent in the second, expert companion autonomous-driving interaction mode 230 as compared to the first, novice autonomous-driving interaction mode 220. Because the human driver associated with the second, expert companion autonomous-driving interaction mode 230 is deemed to be more comfortable with automated functions than the novice, the system 120 is configured to more-frequently initiate a TOC to the vehicle 100. The system 120 may initiate TOC to the vehicle automatically in situations such as when the vehicle reaches a low-traffic highway driving condition. The system 120 can still in the second autonomous-driving interaction mode 230 advise the driver or request approval for the TOC in advance.

As for all autonomous-driving interaction modes, if the system 120 determines that the human driver is not comfortable with automated functions and a present level of interaction (e.g., the level of the expert companion interaction mode), the system 120 can propose to the human driver that the system 120 operate at a lower autonomous-driving interaction mode. In a contemplated embodiment, the system 120 is configured to automatically change autonomous-driving interaction modes as deemed appropriate based on any helpful factor, such as user preferences/settings, user behavior (e.g., driving style, gestures, etc.), and/or user communications (e.g., statements, inquiries, etc.).

As also for each autonomous-driving interaction mode, if the human driver would like more information and/or more manual control—e.g., more frequent TOC to the human driver or less frequent TOC to the vehicle—the human driver may elect to be associated with a lower autonomous-driving interaction mode. Likewise, if the human driver would like less information, less manual control—e.g., less frequent TOC to the human driver—the human driver may elect to be associated with a higher autonomous-driving interaction mode. The increase in user trust may stem from the interaction with the system 120.

III.D. Expert Passenger Interaction Mode 240

The third, or second highest, autonomous-driving interaction mode 240 can be referred to by any of a variety of names, including expert passenger autonomous-driving interaction mode, expert new driver passenger autonomous-driving interaction mode, taxi passenger autonomous-driving interaction mode, high-trust autonomous-driving interaction mode, high-comfort autonomous-driving interaction mode, or the like.

Human drivers, or expert passengers, best associated with this autonomous-driving interaction mode generally feel more like a passenger being transported by the car.

The system 120 is configured with data and algorithms informing the system that, when in the expert passenger autonomous-driving interaction mode, the human driver is more comfortable than lower-mode users, and requires still less information about autonomous driving functions. The system 120 is programmed to determine that the expert passenger user may intervene occasionally, but generally views the situation that the user is in a taxi cab. The user may ask questions occasionally, or request TOC to manual driving, but not often.

The system 120 is also programmed to, in this autonomous-driving interaction mode 240, transfer control automatically to the driver less as compared to the lower mode 230, realizing that the driver trusts the vehicle 100 to make needed maneuvers autonomously. The system 120 may transfer control to the driver in critical or safety-sensitive situations for instance.

III.E. Fully Passenger Interaction Mode 250

The fourth, highest, autonomous-driving interaction mode 250 can be referred to by any of a variety of names, including fully expert autonomous-driving interaction mode, fully expert passenger autonomous-driving interaction mode, fully expert driver autonomous-driving interaction mode, fully passenger autonomous-driving interaction mode, train passenger autonomous-driving interaction mode, highest-trust autonomous-driving interaction mode, highest-comfort autonomous-driving interaction mode, maximum trust or comfort autonomous-driving interaction mode, or the like.

Human drivers best associated with this autonomous-driving interaction mode feel completely comfortable with autonomous driving, and can be referred to as expert passengers.

The experience can also be analogized to train operations, with these drivers as train passengers. The human driver, who is mostly or completely a rider, or passenger, does not expect to affect or understand the transportation functions when in this autonomous-driving interaction mode 250. This is different than the user in the prior interaction mode 240, analogized to a taxi ride, wherein a user could expect to interact and affect driving of the taxi at least on a low level.

The system 120 is configured with data and algorithms informing the system that, when in the fully autonomous driving interaction mode, the human driver is completely comfortable with autonomous driving, and requires generally very little or no information about autonomous driving functions being performed.

As mentioned, the system 120 is in some implementations configured and arranged in the vehicle 100 to affect autonomous driving functions, such as gap spacing and transfer of control (TOC).

The system 120 is in various embodiments programmed to, when in this highest autonomous-driving interaction mode 250, avoid, or never affect, transfer control automatically to the driver. The vehicle 100 could be configured to, in a critical situation, for instance, transition immediately to a place of safety, such as by pulling the vehicle over to park.

The system 120 can be programmed to, for instance, assume that the human driver is completely unavailable when the fully autonomous interaction mode 250 is activated. This assumption would be the case in any event (i.e., whichever interaction mode is selected) should the human driver be determined to be unconscious or impaired so that they cannot drive safely.

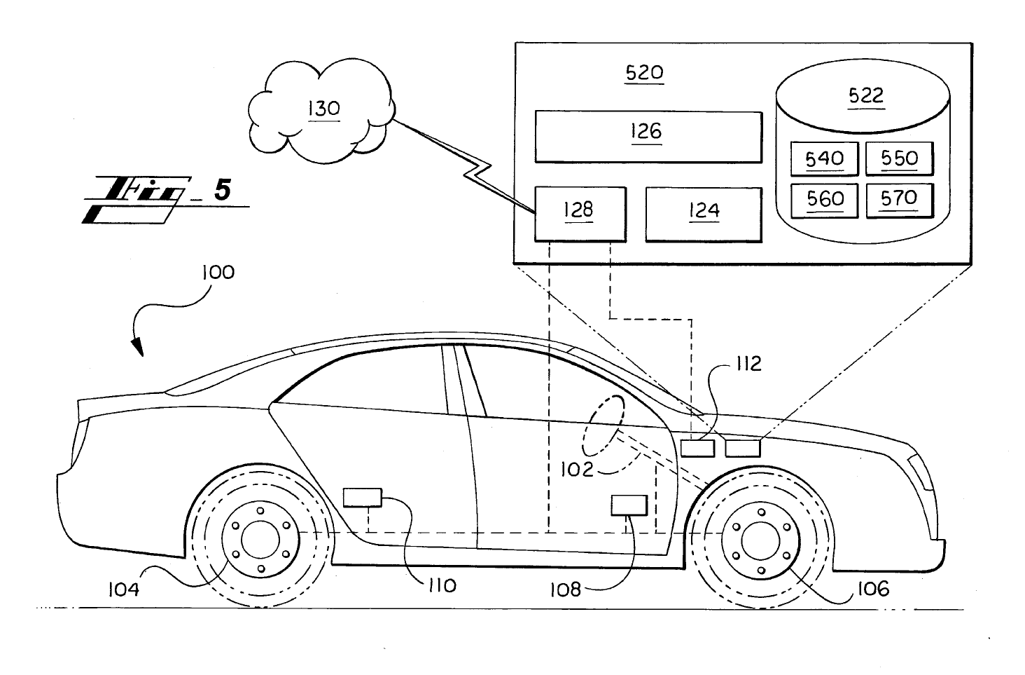

IV. Second Example System Components—FIGS. 5-7

FIG. 5 illustrates schematically a second example vehicle, like that of FIG. 1, but with a distinct controller.

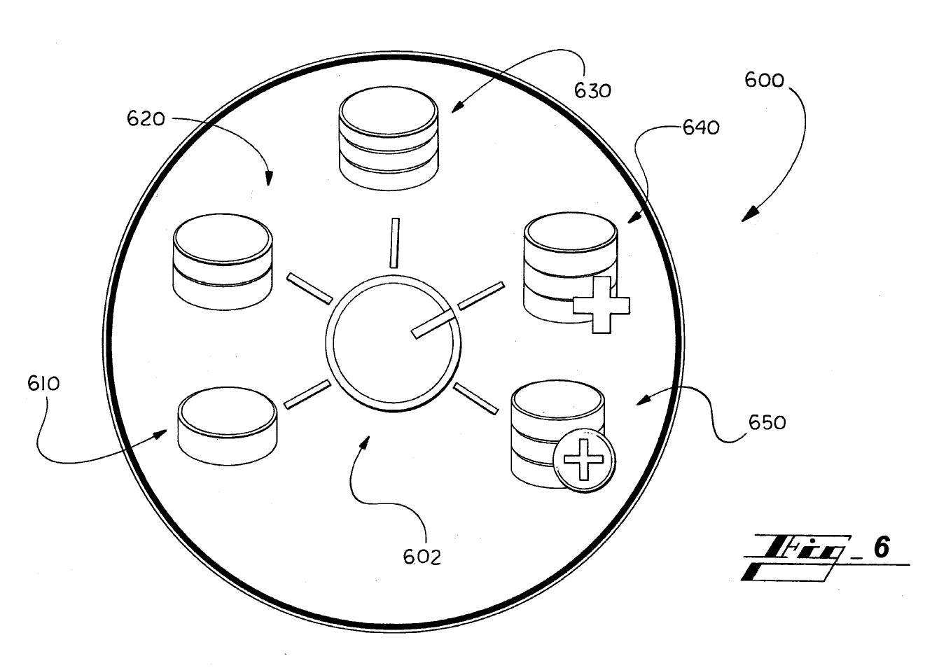

FIG. 6 illustrates a third example system-user interface device.

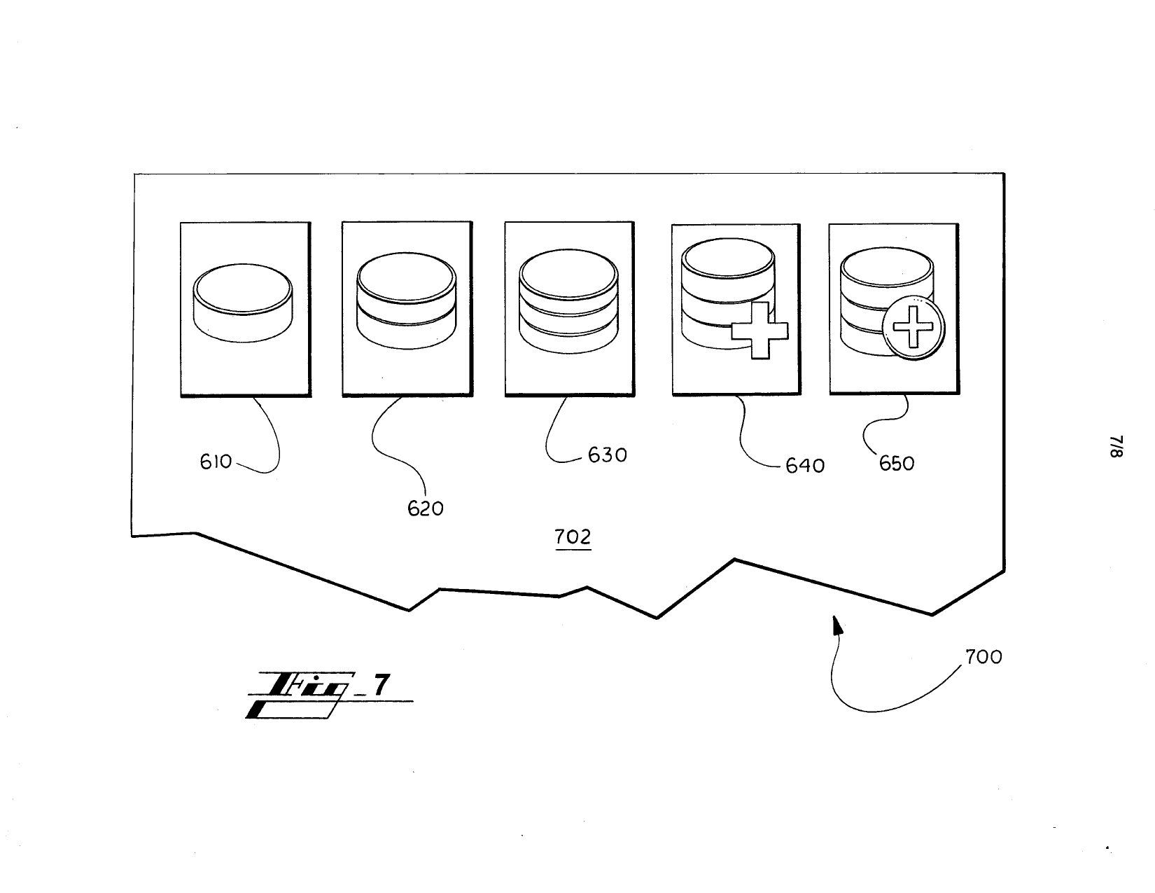

FIG. 7 illustrates a fourth example system-user interface device.

The vehicle 500 can include any of the components described above in connection with the vehicle 100 of FIG. 1. Like components retain the same reference numerals.

A computerized controller, or control system 520 of FIG. 5 can be configured, arranged, and implemented in any of the ways provided for the control system 120 of FIG. 1, and includes programming specific to the embodiments of FIGS. 5-7. Namely, a computer-readable storage device 522 includes computer-executable instructions, or code being executable, by the processing hardware unit 124, to cause the processing hardware unit, and thus the control system 520, to perform any combination of the functions specific to FIGS. 5-7.

The storage device 522 is in various embodiments divided into multiple modules 540, 550, 560, 570, each comprising or being associated with code causing the processing hardware unit 124 to perform functions described herein.

The control-system modules 540, 550, 560, 570 in various embodiments include an information-level, or interaction-level determination module 540, an information-level, or interaction-level actualization module 550, a user-profile module 560, and one or more other modules 570.

The interaction-level determination module 540 is configured with computer-executable code designed to cause the processing hardware unit 124 to perform functions related to determining an applicable information-sharing, or cooperation, level in connection with a particular vehicle or user (e.g., vehicle driver).

Determining the applicable information level is performed by the processing hardware unit 124 in any one or more manners. In various embodiments, determining the applicable information level includes receiving a user signal or user message indicating a user-selected information level of multiple information level options presented to the user. In some embodiments, the determination is made with consideration given to other context data (e.g., user-context data), such as user activity, as described further below.

The user signal or message indicating the user-selected information level is in various embodiments received from a user input. The user-input can include user manual selection, provided by way of an interface component of the vehicle 500 or another user device. Other example user devices include user computers and mobile communications devices, such as smart phones, tablets, or laptops.

Example vehicle-user interfaces include a microphone, a knob or a dial, and a touch-sensitive display. Example user-input devices include the device 600, including dial or knob 602, of FIG. 6, and the device 700, including touch-sensitive display 702, of FIG. 7.

The example vehicle-user interfaces 600, 700 of FIGS. 6 and 7 show, by way of illustration, five (5) interaction-level modes 610, 620, 630, 640, 650 to which a user can set the system to operate.

The performing system can include the controller 520 and/or a remote computing system, such as a remote server.

The system can include more or less settings, and in various embodiments it is possible for the system to operate in a manner consistent with a level between two pre-established modes. The selected mode can fall between the third and fourth pre-established modes, for example. An adjustment from any pre-set interaction-level mode can be made based on user-specific or vehicle-specific context data.

A system could be programmed to determine that although the user selected the third mode, based on user actions (e.g., requesting more data regularly), the operation mode should be the fourth mode, or an intermediate mode between the third and fourth. In some implementations, the system recommends or advises the user about the plan to change interaction-level mode, or about a mode changed effected. In some implementations, the system is programmed so that user approval is needed to make the change. The system can be programmed so that such approval is required, or more likely to be required, for higher levels (e.g., a highest level, or two highest levels). In some cases, the system is programmed so that the change is made without requiring approval, or even without notice to the user, especially at lower, or the lowest few levels.

The remote computer or server could be a part of a customer-support center, such as the OnStar® system. OnStar is a registered trademark of the OnStar Corporation, which is a subsidiary of the General Motors Company. Such centers have facilities for interacting with the vehicle, such as for telematics data, and with the user, via the vehicle or other communication device—phone, tablet, laptop, desktop, etc.

In some embodiments, as referenced above, the system selects an applicable interaction-level mode, with or without consideration given to user selection or input.

Generally, the interaction-level mode determined controls a manner of communication or interaction, by which vehicle-related information is provided to the user and, in some cases, by which related actions are initiated or performed.

The manner of communication or interaction can include a variety of communication or interaction characteristics, such as an amount of information, or feedback, that the user will receive about the vehicle. The information in various embodiments relates to the vehicle, or use of the vehicle. The manner of communication can also include communication characteristics such as timing, or schedule, of messaging, type (e.g., content, color, audio volume, size, etc.) and a channel by which the communications are provided—e.g., vehicle screen, user mobile device, etc.

The manner of interaction can also include whether notifications of certain actions, such as software updates are provided, and whether user approval of such actions is required.

Example pieces of information include information related to vehicle state, such as fuel level, oil level, temperature, vehicle location, etc. In some implementations, information communicated to the user indicates a needed or recommended vehicle maintenance, or statistics about vehicle use—e.g., highway driving mileage vs. city-driving mileage. In various embodiments, the information indicates a current vehicle speed, current vehicle mileage, a software update available, service alerts, points of interest, the like, or other.

While the example interaction-level modes 620, 630, 640, 650 are described in large part separately below, the information shared in any one mode can, in various embodiments, be shared in other modes as well, in the same, similar, or different manner—e.g., volume, timing, channel, type (e.g., content, color, audio volume, size), etc.

In various embodiments, the interaction-level mode determined also affects whether some actions require user-confirmation, or opting in/opting out, before being performed.

In some cases, the system is configured to, for one or more interaction-level modes, perform some activities (e.g., software update) automatically, without notice, while the same tasks would be performed only after communication to the user at one or more higher level modes, and perhaps only after user approval at one or more high modes.

For instance, at a low level mode, such as 610, 620, the system may advise the user by message of a software update, and continue to perform the update automatically, without requiring the user to approve the activity. For a higher level mode, such as 640 or 650, because a desire or need for increased information and interaction has been determined, by the user and/or system, the system may be configured to ask the user for approval to perform the activity.

The first interaction-level mode 610 represents a lowest level of information provision. In various embodiments, when the system is set to the first interaction-level mode 610, a lowest amount of information is shared and/or information is provided less frequently. The user and/or the system may select this level for situations in which the user wants, or apparently wants, very little information communicated to them about vehicle operations and/or wants information provided to them less frequently. The basic information communicated can include, for instance, vehicle speed, vehicle mileage, and vehicle fuel level.

The second interaction-level mode 620 represents a second lowest, or “low,” level of information provision. In various embodiments, when the system is set to the second interaction-level mode 620, the information shared can include the information of the lower level (mode 610) provided at the same or an increased frequency, and additional information. Example other information includes information about software updates available and service alerts. Service alerts can include, for instance, fixed service notices, such as when a next oil change or general vehicle maintenance is needed.

For higher levels—e.g., the third interaction-level mode 630 representing a medium level of information provision, the fourth interaction-level mode 640 representing a second highest, or “high,” level of information provision, and the fifth interaction-level mode 650 representing a highest level of information provision—the trend (from the lower levels 610, 620) continues, whereby, generally, more information is provided to the user about vehicle status and activities, information is provided more frequently, and/or more user-approval is required for activities.

At higher-level modes, alerts or notices can be more personalized, as compared to being more fixed. An example of a fixed-type notice is: “Just a reminder—Oil change needed in 50 miles.” A more personalized-type notice could be, for instance: “Based on your calendar, you have a long drive this weekend—Oil Change recommended before then,” by any communication channel, or, “Oil change needed” texted to a person who has communicated a preference to receive text messages.

At higher-level modes, messages can still be provided to the user entirely by the vehicle, or can be more likely provided also by communication channels other than the vehicle (e.g., offline from the vehicle). Example non-vehicle channels include a user phone, tablet, or computer.

In some embodiments, how a message is provided to the user is determined by the processing hardware unit 124 executing code of the interaction-level actualization module 550. That activity can include considering user preferences (of, e.g., the user-profile module 560) along with the level determined using the interaction-level determination module 540.

For higher-level modes, the system is in some embodiments configured to use preferences or other user-specific information more, such as of a user profile (e.g., user-profile module 560), in determining the manner (e.g., amount, timing, type (content, color, audio volume, size, etc.), channel) by which to provided information to the user.

The system monitors user behavior or activity, and uses results of the monitoring in determining the manner by which to provide to the user. The user activity can include user-driving characteristics, such as when they drive, speeds, and where, such as points of interest (POIs).

For instance, the system may determine when to send a notification, how the notification is configured, and/or by what communication channel to provide the notification, for example, based on user-activity patterns. For example, if the user has a regular long commute on Friday afternoons, the system may determine to share certain information during that time, and by the speaker system to minimize distraction during the drive. Or if the user is known to be waiting at the train station on Monday mornings, the system may send text notices about vehicle status or activity to the user at that time.

In various embodiments, the system can be configured to allow the user to adjust any system setting, such as a setting affecting the manner by which information is provided to the user—e.g., when or how a message is provided to the user, and in what format. The user may advise the system that audible messages are preferred, for instance. Such preferences can be stored, for instance, at a user account associated with the user profile module 560.

After the processing hardware unit 124 determines an applicable information level, using the interaction-level determination module 540, the unit 124 proceeds to provide information to the user according to the level determined.

In some embodiments, how a message is provided to the user is determined by the processing hardware unit 124 executing code of the interaction-level actualization module 550. The activity can include considering user preferences (of, e.g., the user-profile module 560) along with the level determined using the interaction-level determination module 540.

Activity of the processing hardware unit 124 executing the interaction-level actualization module 550 also includes initiating transmission, or other provision, of one or more messages to the user consistent with the information level determined using the interaction-level determination module 540.

In some embodiments, determining what messages to provide to the user is performed by the processing hardware unit 124 executing the interaction-level actualization module 550. As mentioned, such activity can include reference to a user account, such as of the user-profile module 560.

The fourth illustrated module 570 can represent one or more additional modules. Example functions that code of the additional module(s) 570 can cause the processing hardware unit 124 to perform include building or updating the user profile. The user profile can include user settings, or preferences that the user has input or expressed, or that the system 520 has determined based on user behavior. The user behavior can include, e.g., requesting more or less information when certain conditions are present, such as while travelling away from a home area, on weekends, etc. The user input can include, for instance, user communications, such as statements, inquiries, gestures, etc.

The modules 540, 550, 560, 570 can be referred to by a wide variety of terms including by functions they are configured to perform. The module 570 can be referred to, for instance, as a user-profile-builder module, the like, or other name consistent with its functions.

While four modules 540, 550, 560, 570 are illustrated in FIG. 5 by way of example, the non-transitory computer-readable storage device 522 can include more or less modules. Any functions described herein in connection with separate modules can instead, in another embodiment, be performed by the processing hardware unit 124 executing code arranged in a single module. And any functions described herein in connection with a single module can be performed instead by the processing hardware unit 124 executing code of more than one module.

The control system 520 further comprises an input/output (I/O) device 128, such as a wireless transceiver and/or a wired communication port. The device 128 can include, be a part of, or be a tangible communication device. The processing hardware unit 124, by way of the I/O device 128, and executing the instructions, including those of the mentioned modules 540, 550, 560, 570, sends and receives information, such as in the form of messages or packetized data, to and from one or more vehicle components, including the vehicle control components 102, 104, 106, 108, 110 mentioned.

In some implementations, the I/O device 128 and processing hardware unit 124 are configured such that the processing hardware unit 124, executing the instructions, sends and receives information to and from one or more networks 130 for communication with remote systems. Example networks 130 can include the Internet, local-area networks, or other computing networks, and corresponding network access devices include cellular towers, satellites, and road-side short- or medium-range beacons such as those facilitating vehicle-to-infrastructure (V2I).

The system can also interface by the networks 130 with user devices or networks such as a smart phone, a tablet, a home network, etc.

In some embodiments, such as when the system 520 is implemented within a vehicle 500, the system 120 includes or is connected to one or more local input devices 512 and/or one or more output devices 104, 106, 108, 110, 512, 114. The inputs 512 can include in-vehicle knobs or dials (602 in FIG. 6, for instance), touch-sensitive screens (FIG. 7 for instance), switches, microphones, cameras, laser-based sensors, other sensors, or any device suitable for monitoring or receiving communication from a user (e.g., driver) of the vehicle 500. User communication can include, for instance, gestures, button pushes, or sounds. The user communications can include audible sounds such as voice communications, utterances, or sighs from the user.

In various embodiments, any one or more of the first three described modules 540, 550, 560 are configured to generate at least one tutoring system message to include content configured to educate or teach the driver. In one embodiment, the tutor message is provided by a module focused on providing the tutor message, which can be referred to as a tutoring module, an education module, a teaching module, or the like, for instance. Generation and provision of tutoring messages are, in various embodiments, performed by a tutoring module, being one of one or more modules represented by numerals 570 in FIG. 5. In various embodiments, the tutoring module is part of one of the first three described modules 540, 550, 560.

The teaching or tutoring message can relate to, for instance, (1) a vehicle functions that is the subject of a vehicle-related message provided to the driver or to be provided to the driver, (2) channels by which the system can provide such vehicle-related messages to the driver, (3) content of the vehicle-related messages (e.g., explanation at an easily understood level about what the data being provided means), (4) user-system interaction-level mode options, (5) interface(s) by which the driver can select a user-system interaction-level mode (e.g., the interface devices of FIGS. 6 and 7), (6) how the system determines or determined an appropriate user-system interaction-level mode, which may include consideration of a driver-selected mode and/or other user context data, such as driver actions or behavior, (7) system settings, (8) driver settings or preferences, and (9) how the driver can change system settings.

Further regarding the tutoring module, the system is in various embodiments configured to determine that the driver is not using one or more vehicle functions, such as related to autonomous-driving. This may be the case if, for instance, a higher level of interaction is effected—the driver could be receiving very little information and the system can determine that they driver would likely benefit from receiving one or more pieces of information that are not currently provided at the effected level of interaction. In various embodiments, the tutoring messages can include suggestions or recommendations, such as recommendations of which information to receive from the system, or which level of interaction the driver may want to switch to. The recommendations or other tutoring messages can be based on various context information, such as the level of interaction selected, user behavior or other user action, user preferences or settings, and a level or mode to which an autonomous-driving system of the vehicle is set.

In some embodiments, vehicle functions information form the tutoring message relates to one or more autonomous-driving actions of the vehicle.

The tutoring messages can be configured and provided toward accomplishing any of wide variety of goals, including engendering driver confidence, trust, and comfort in the vehicle, such as in autonomous-driving operation of the vehicle. The tutoring messages, e.g., recommendations, can also be configured and provided to promote the driver testing and/or using vehicle functions, including autonomous driving capabilities of the vehicle system, or different levels of information interaction available by way of the vehicle, or different amounts or types of information that the vehicle system can make available to the driver, for instance.

The tutoring message can be provided (A) in advance of a corresponding vehicle function, such as an autonomous-driving action, (B) during such function, or (C) following such function.

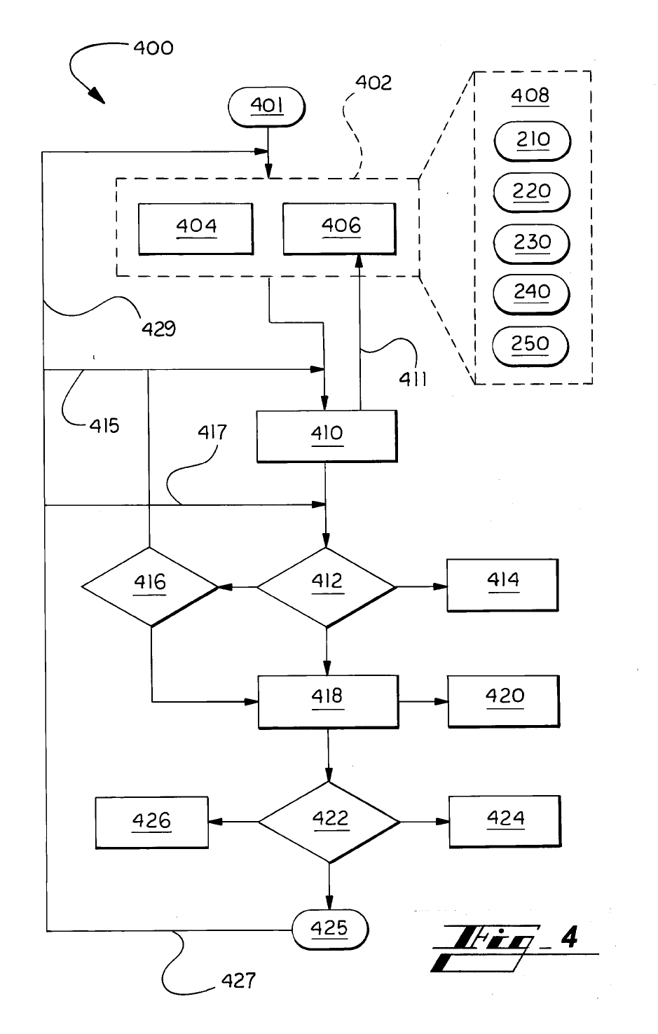

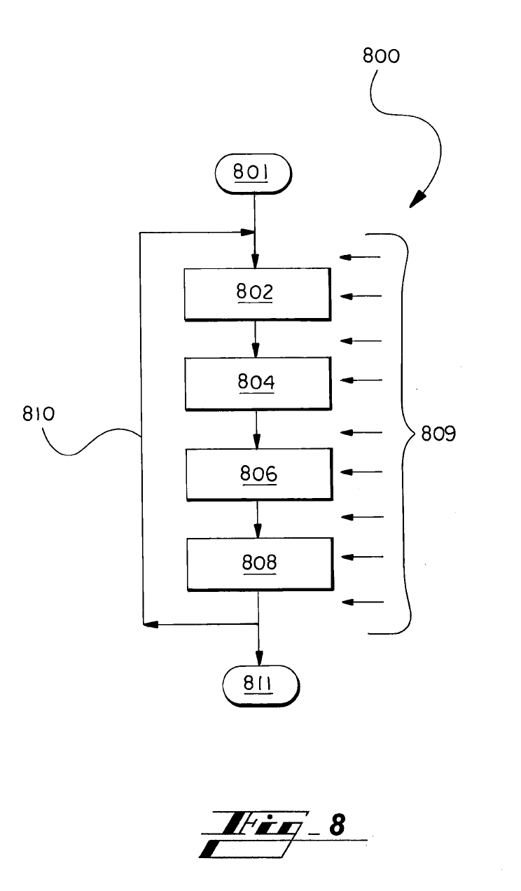

V. Methods of Operations—FIGS. 4 and 8

FIG. 4 shows an algorithm by which the embodiments described in the third section (III), above, in connection with FIGS. 1-3, are implemented. The algorithm is outlined by flow chart as a method 400, for use at the autonomous-driving -capable vehicle 100, according to various embodiments of the present disclosure.

FIG. 8 shows an algorithm by which the embodiments described in the fourth section (IV), above, in connection with FIGS. 5-7, are implemented. The algorithm is outlined by flow chart as a method 800, for use at the autonomous-driving-capable vehicle 500, according to various embodiments of the present disclosure.

It should be understood that operations of the methods 400, 800 are not necessarily presented in any particular order and that performance of some or all the operations in an alternative order is possible and is contemplated. The operations have been presented in the demonstrated order for ease of description and illustration. Operations can be added, omitted and/or performed simultaneously without departing from the scope of the appended claims. It should also be understood that the illustrated method 400 can be ended at any time.

The methods 400, 800 can be performed separately or together.

In certain embodiments, some or all operations of the methods 400, 800, and/or substantially equivalent operations are performed by execution by the processing hardware unit 124 of computer-readable instructions stored or included on a non-transitory computer-readable storage device, such as the storage device 122 shown in FIGS. 1 and 5. The instructions can be arranged in modules, such as the modules 140, 150, 160, 170 described in connection with FIG. 1 and the modules 540, 550, 560, 570 described in connection with FIG. 5.

The first method 400 begins 401 and flow proceeds to block 402, whereat the processing hardware unit 124, executing code of the mode-determining module 140 determines an applicable interaction mode corresponding to a user (e.g., vehicle driver) of the autonomous-driving-capable vehicle. In some embodiments, the mode-determining module 140, in being configured to determine the applicable interaction mode corresponding to the driver of the autonomous-driving-capable vehicle, is configured to select the applicable interaction mode from a plurality of pre-established interaction modes. Example interaction modes are indicated generally by reference numeral 408 in FIG. 4, and include the same example interaction modes indicated above—for example: the manual-driving interaction mode 210 and four interaction modes 220, 230s, 240, 250.

The mode-determining module 140 can be configured to cause the processing hardware unit 124 to make the selection based on express user input received at a tangible input component and indicating an interaction mode desired. Selection based on such user input, indicating the mode expressly, is indicated by block 404. Example inputs, or vehicle-user interfaces, include a microphone, a knob or a dial, such as the device 200 of FIG. 2, and a touch-sensitive display, such as the arrangement 300 of FIG. 3.

In various embodiments, mode-determining module 140 can be configured to cause the processing hardware unit 124 to determine a recommended system interaction level for the user based on user communications, settings, preferences, or behavior, such as driving behavior or responses to autonomous driving operations such as transfers of control from the driver to the vehicle or vice versa. The system 120 recommending and selecting, or just determining, an applicable mode is indicated by block 406.

At block 410, the interaction module 150 causes the processing hardware unit 124 to receive and process information regarding the user. The information can include a user communication (statement, inquiry, gesture, utterance, for example) or a user preference communicated expressly or determined from context including user communications, for instance.

As described above, in some embodiments the system 120 is configured to monitor the human driver. The monitoring can be performed in connection with block 410, for example. The monitoring can be performed more when the interaction mode is higher (e.g., novice mode 220) than when the interaction mode is lower (e.g., expert passenger mode 230, et seq.). Monitoring more can include monitoring more frequently, for instance, and/or to a higher degree—e.g., configured to in addition to picking up communications made by way of a microphone or a touch-sensitive screen, pick up more communications, such as by a camera or laser-based sensor system detecting user gestures.

The system 120 is in some embodiments configured to recommend, or simply determine and change, an applicable interaction mode based on user behavior, settings, and/or the like. This can occur at various stages of the method 400, and is shown by way of example by reference numeral 411 in FIG. 4.

At block 410, the interaction module 150 could also cause the processing hardware unit 124 to determine a responsive operation to perform in response to the driver communication. The block 410 can include initiating the performance or actually performing the operation determined.

Example responsive operations include (i) determining an autonomous-driving action based on the driver communication, (ii) providing a system recommendation, based on the driver communication, to perform an autonomous-driving action, (iii) initiating an autonomous-driving action based on the driver communication, (iv) initiating early performance of an autonomous-driving action to alleviate a driver concern indicated by the driver communication, (v) initiating a transfer of vehicle control, to the system from the driver or to the driver from the system, in response to the driver communication, (vi) determining the applicable interaction mode based on the driver communication, (vii) changing the applicable interaction mode based on the driver communication, (viii) proposing an alternative interaction mode based on the driver communication, (ix) determining a responsive message, based on the driver communication, comprising information requested by the driver communication, (x) determining, based on the driver communication, a responsive message configured to alleviate a driver concern indicated by the driver communication, and (xi) establishing, based on the driver communication, a driver preference to affect autonomous-driving actions of the vehicle.

Continuing with the algorithm 400, the interaction module 150 is configured to, at diamond 412, cause the processing hardware unit 124 to determine whether a pre-autonomous action message should be provided to the human driver.

In response to an affirmative determination at diamond 412 (i.e., that a message should be provide), flow proceeds to at least block 414 whereat the processing hardware unit 124, executing code of the storage device 122, initiates communication of the message to the human driver.

The communication of block 414 is provided based on the applicable interaction mode determined at 402 and related to one or more autonomous-driving activities or functions of the vehicle 100. In situations in which a communication is provided to the human user by the system 102 without the human user prompting for the communication, the communication, and system function, can be referred to as proactive. The system and functions in this case, and all instances regarding system functions can be referred to also as intelligent because they are related to providing system-user interactions at a level customized to the user situation.

The communication can include more information when the interaction mode is higher (e.g., novice mode 220) than when the interaction mode is lower (e.g., expert passenger mode 230, et seq.). Additional information can include information configured to educate the human driver about autonomous functions, to engender trust and comfort in the human driver with the autonomous driving capabilities. These type of communications, or the function of providing them, can be referred to by a variety of terms, such as tutoring, educating, training, informing, or the like.

In addition to increasing human-driver trust and comfort with the autonomous-driving functions of the vehicle 100, interactions—e.g., messaging—can be configured to inform the user particularly of autonomous driving functions that the user may not be aware of. Some of these functions can be referred to as advanced, or more-advanced functions. A user may be well aware of more basic functions, such as the vehicle being capable of adaptive cruise control and lane-keeping in highway conditions, for instance, but not that the vehicle can parallel park itself, or is capable of quickly identifying and avoiding an expected road hazard.

Advanced features are also in these ways made more accessible for less-experienced drivers. A human driver unexperienced with the autonomous-driving -capable vehicle 100 will be more likely to use an advanced autonomous driving features, or any autonomous-driving feature, if the vehicle 100 is interacting with them before, during, and/or after an autonomous maneuvers, and especially with respect to those maneuvers that the human driver may otherwise feel uncomfortable with the vehicle handling autonomously.

The communication can be made by any suitable communication interface. The interface includes hardware by which a user, such as a driver of the vehicle, can provide input and/or receive output from a computerized controller of the vehicle. This vehicle-driver interface (VDI) is indicated schematically by reference numeral 112. The VDI 112 can be referred to by a variety of terms. The VDI can also be referred to as a human-machine interface (HMI), a vehicle input, a vehicle I/O, etc. Example interfaces include a display-screen component, a heads-up display unit, and an audio-speaker component.

If, in addition to an affirmative determination at diamond 412 (i.e., that a message should be provide), the system 120 determines that the message should be a human-driver inquiry, flow proceeds also to 416 whereat the processing hardware unit 124 monitors for or at least receives a human-driver response.

The human-driver response received at diamond 416 can include, for instance, an approval of an autonomous driving maneuver proposed to the human driver at block 414. In some implementations, such approval is required before the system 120 initiates the maneuver proposed. In such case, if the human-driver response received at diamond 416 does not include an approval, flow of the algorithm 400 can proceed along path 415 or path 417.

For cases in which (i) human-driver approval is received, (ii) the approval is not required in connection with the monitoring of diamond 416, or (iii) a negative determination is reached at diamond 412 (i.e., that a message should not be provide), flow proceeds to block 418.

Information collected or generated at diamond 416 can be used in a variety of ways. These ways include those reference above—for instance, to create or adjust user settings or preferences, or to determine or recommend a different interaction mode 210, 220, 230, 240, 250 (analogous to flow path 411) based on the information.

At block 418, the vehicle-maneuver module 160 causes the processing hardware unit 124 to determine an autonomous driving maneuver or action to take. The module 160 can be configured to cause the processing hardware unit 124 to determine the maneuver based on the applicable interaction mode determined at 402. The maneuver can be less aggressive, such as by being performed at a lower vehicle speed, for instance, when the interaction mode is higher (e.g., novice mode 220) as compared to when the interaction mode is lower (e.g., expert passenger mode 230, et seq.).

At block 420, the vehicle-maneuver module 160 causes the processing hardware unit 124 to initiate the maneuver determined.

At diamond 422, the vehicle-maneuver module 160 or the interaction module 150 causes the processing hardware unit 124 to determine whether a post-autonomous-maneuver message should be provided to the human driver.

While pre-autonomous-maneuver communications (412/414) and post-autonomous-maneuver communications 422/424) are described primarily, it should be appreciated that intra-autonomous-maneuver, or during-maneuver, communications can also be provided to the human driver for stated purposes, such as to calm or educate the human driver.

In response to an affirmative determination at diamond 422 (i.e., that a message should be provide), flow proceeds to at least block 424 whereat the processing hardware unit 124 initiates communication of the message to the human driver.

The communication of block 424 is provided based on the applicable interaction mode determined at 402 and related to the autonomous-driving activity performed by the vehicle 100. As with the communication of block 414, the communication of block 424 can include more information when the interaction mode is higher (e.g., novice interaction mode 220) than when the interaction mode is lower (e.g., expert passenger interaction mode 230, et seq.). Again, the information can include tutoring- or education-based information, as mentioned in connection with the communication of clock 424, to promote human-driver trust and comfort with autonomous driving functions.

The communication can be made by any suitable communication interface, including by one or more of the exemplary devices 112 described above.

In some embodiments, the interaction module 150 is configured to cause the processor to at block 426 monitor the human user for, or at least receive from the human user, feedback responsive to the message communicated via block 424. The message of block 424 could be an inquiry for instance—“was that a comfortable passing maneuver?”, for example—and the feedback at block 426 can include a response.

As with all information collected or generated based on communications or behavior of the human driver, information from block 426 can be used in a variety of ways. These ways include those referenced above—for instance, to create or adjust user settings or preferences, or to determine or recommend a different interaction mode 210, 220, 230, 240, 250 (analogous to flow path 411) based on the information.

The method 400 can end 425, or any one or more operations of the method 400 can be performed again, as indicated in FIG. 4 by path 427 which can flow, by way of example, to paths 415, 417, or 429.

Aspects of the method 800 are described above in connection with the modules 540, 550, 560, 570 of FIG. 5, and are provided by the flow chart of FIG. 8.

The method 800 commences 801 and flow proceeds to the block 802 whereat the processing hardware unit 124, executing the interaction-level determination module 540, determines an applicable information level for use in sharing vehicle-related information with the user.

The determination of block 802 can include processing of user feedback, such as by user feedback received by way of the interfaces 600, 700 shown in FIGS. 6 and 7. Another example interfaces include a voice-based interface, such as one including a microphone, and a visual-based interface, such as one including a camera for sensing user gestures. More about the determination 802 is provided above in connection with FIG. 5, and particularly regarding structure of the interaction-level determination module 540.

At block 804, the processing hardware unit 124 identifies a manner by which to provide the vehicle-related information to the user (e.g., vehicle drier). The manner can include, for instance, an amount of volume of messages, a timing or schedule for the messaging, a channel for the messaging (e.g., vehicle screen, vehicle speaker, user mobile device).

The function 804 can also be performed by the processing hardware unit 124 executing code of the interaction-level determination module 540 and/or the interaction-level actualization module 550. More about the function 806, such as considerations of user preferences or historic activities, is provided above in connection with FIG. 5, and particularly regarding operation of the interaction-level determination and interaction-level actualization modules 540, 550.

The manner can include message type—e.g., content, structure, format, color, audio volume, size, etc. The operation 804 can thus include obtaining one or more messages of an appropriate type, such as by determining, identifying, or generating one or more messages for sharing with the user. The function can be performed by the processing hardware unit 124 executing code of the interaction-level determination module 540 and/or the interaction-level actualization module 550. More about the function 804, such as considerations of user preferences or historic activities, is provided above in connection with FIG. 5, and particularly regarding operation of the interaction-level determination and interaction-level actualization modules 540, 550.

At block 806, the processing hardware unit 124 initiates communication of the one or more messages to the user. The message(s) can be provided by way of a vehicle screen, vehicle speaker system, and/or other user communication device (e.g., phone or tablet), for instance. The function 808 is in most cases performed at least in part by the processing hardware unit 124 executing code of the interaction-level actualization module 550.

At block 808, the processing hardware unit 124 considers any user feedback and updates a user account as needed. The feedback can include approval to make a software update for example, and, in some implementations, a request for permission to make such updates going forward automatically, without user approval. As another example, the feedback can indicate that the user would like more or less information.

The function 808 can be performed by the processing hardware unit 124 executing code of any of the modules disclosed, such as the user-profile module 560 and/or the other module(s) 570—e.g., the user-profile-builder module mentioned above.

At any point, as indicated by reference numeral 809, the process 800 can include generation and provision of one or more tutoring messages, referenced above. The generation and provision in various embodiments are performed by one of the first three aforementioned modules, 540, 550, 560, or could be performed by another module, such as a tutoring module, being one of one or more modules represented by numerals 570 in FIG. 5. In various embodiments, the tutoring module is part of one of the first three described modules 540, 550, 560. The tutoring module and tutoring messages are described above and not further here.

The method 800 can end 811, or any one or more operations of the method 800 can be performed again, as indicated in FIG. 8 by path 810.

VI. Select Benefits of the Present Technology

Many of the benefits and advantages of the present technology are described above. The present section restates some of those and references some others. The benefits are provided by way of example, and are not exhaustive of the benefits of the present technology.

The systems described above in connection with FIGS. 5-8 especially promote customized user communication.

The communications, provided based on a pre-determined interaction-level mode determined most appropriate for a user, are less obtrusive than the messages provided by any one-size-fits-all system providing information basically without regard to user experience and preferences. User experience and preferences can advise the system on matter such as, for example, regarding message volume of messages, configurations of the messages, and by which channel(s) (e.g., vehicle display or mobile phone) the messages are sent.

Users are more likely to process messages when they are provided at a customized level, such as timing, format, and channel.

Users are less likely to be frustrated by the vehicle when notifications and alerts are provided at a customized level, such as timing, format, and channel.

VII. Conclusion

Various embodiments of the present disclosure are disclosed herein. The disclosed embodiments are merely examples that may be embodied in various and alternative forms, and combinations thereof.

The above-described embodiments are merely exemplary illustrations of implementations set forth for a clear understanding of the principles of the disclosure. Variations, modifications, and combinations may be made to the above-described embodiments without departing from the scope of the claims. All such variations, modifications, and combinations are included herein by the scope of this disclosure and the following claims.

What is claimed is:

1. A vehicle system, for use in communicating in a customized manner with a vehicle user, comprising:
a processing hardware unit;
a tangible interface device in communication with the processing hardware unit for receiving user input and/or delivering vehicle output;
an interaction-level determination module configured to, by way of the processing hardware unit, determine, based on user-context data, an applicable interaction-level mode for use in communicating with the vehicle user; and
an interaction-level actualization module configured to, by way of the processing hardware unit, initiate provision of one or more vehicle-related messages in a manner consistent with the interaction-level mode determined.

2. The vehicle system of claim 1, wherein the user-context data includes input data indicating a user-selected interaction-level mode of a plurality of predetermined interaction-level mode options presented to the user.

3. The vehicle system of claim 2, wherein the plurality of predetermined interaction-level mode options comprise three or four options.

4. The vehicle system of claim 2, wherein the input data is received from the tangible interface device including an in-vehicle knob or dial configured to receive user selection of one of the predetermined interaction-level mode options.

5. The vehicle system of claim 2, wherein the input data is received from the tangible interface device including an in-vehicle display screen configured to receive user selection of one of the predetermined interaction-level mode options.

6. The vehicle system of claim 1, wherein the manner includes at least one factor selected from a group consisting of:
a volume of messages to be communicated;
a timing by which to communicate the message(s);
a message format by which to communicate the message(s); and
whether a user confirmation is requested prior to performance of a vehicle action suggested to the user; and
an applicable communication channel by which to communicate the message(s).

7. The vehicle system of claim 1, wherein:
the manner includes an applicable communication channel by which to communicate the message(s); and
the applicable communication device includes the tangible interface device.

8. The vehicle system of claim 1, wherein:
the manner includes an applicable communication channel by which to communicate the message(s); and
the applicable communication device is a user device remote to the vehicle system.

9. The vehicle system of claim 1, wherein the user-context data includes user-activity data indicating user behavior.

10. The vehicle system of claim 1, wherein the interaction-level actualization module is configured to, by way of the processing hardware unit, determine or generate the one or more vehicle-related messages based on the applicable interaction-level mode determined.

11. The vehicle system of claim 1, comprising a user-profile module configured to be used by the processing hardware unit in determining the manner by which to provide the one or more vehicle-related messages.

12. The vehicle system of claim 11, wherein the user-profile module includes user-preference data, user-activity data, and/or user-behavior data.

13. The vehicle system of claim 1, comprising a tutoring module configured to, by way of the hardware processing unit, generate a tutoring message to educate the vehicle user about vehicle-system operation and thereby engender driver confidence in the vehicle system.

14. The vehicle system of claim 13, wherein the tutoring module is configured to initiate communication of the tutoring message for receipt by the vehicle driver:
in advance of a corresponding vehicle function;
during the corresponding vehicle function; or
after the corresponding vehicle function.

15. A system, for use in communicating in a customized manner with a vehicle user, comprising:
a processing hardware unit;
an interaction-level determination module configured to, by way of the processing hardware unit, determine, based on user-context data, an applicable interaction-level mode for use in communicating with the vehicle user; and
an interaction-level actualization module configured to, by way of the processing hardware unit, initiate provision of one or more vehicle-related messages in a manner consistent with the interaction-level mode determined.

16. The system of claim 15, wherein the user-context data includes input data indicating a user-selected interaction-level mode of a plurality of predetermined interaction-level mode options presented to the user.

17. The system of claim 15, wherein the manner includes at least one variable selected from a list consisting of:
a volume of messages to communicate;
a timing by which to communicate the message(s);
a message format by which to communicate the message(s);
whether a user confirmation is requested prior to performance of a vehicle action suggested to the user; and
an applicable communication channel by which to communicate the message(s).

18. The system of claim 15, comprising a tutoring module configured to, by way of the hardware processing unit, generate a tutoring message to educate the vehicle user about vehicle-system operation and thereby engender driver confidence in the vehicle system.

19. A method, for use in communicating in a customized manner with a vehicle user, comprising:
determining, by a processing hardware unit executing code of an interaction-level determination module of a tangible system, based on user-context data, an applicable interaction-level mode for use in communicating with the vehicle user; and
initiating, by the processing hardware unit executing code of an interaction-level actualization module of the tangible system, provision of vehicle-related messages in a manner consistent with the interaction-level mode determined.

20. The method of claim 19, comprising generating, by the processing hardware unit executing code of a tutoring module, a tutoring message, and initiating communication to the vehicle user, to educate the vehicle user about vehicle system operation and thereby engender driver confidence in the vehicle system.
